(19) United States
(12) Patent Application Publication
(10) Pub. No.: US 2013/0276639 A1
(43) Pub. Date: Oct. 24, 2013

(54) PORTABLE CUP FOR BREWING

(71) Applicant: Chia-Ching Chen, Taichung (TW)

(72) Inventor: Chia-Ching Chen, Taichung (TW)

(21) Appl. No.: 13/452,938

(22) Filed: Apr. 23, 2012

(51) Int. Cl. A47J 31/44; A47J 31/06

(52) U.S. Cl. 99/323; 99/279

(57) ABSTRACT

A portable cup for brewing includes a cup. A bottom of the cup is defined as a bottom cap. A receiving space is defined on the upper surface of the bottom cap. A food product is received in the receiving space. A soluble edible gum seals the receiving space. Wherein, the food product is fully protected by the soluble edible gum from exposing in the air for preserving the food product from corrupt.

### BACKGROUND OF THE INVENTION

1. Field of the Invention

The present invention relates to a portable cup, and more particularly to a portable cup for brewing.

2. Description of Related Art

Recently, tea leaf, milk powder and coffee are food products which are usual in our life. For the purpose of portability, the above food products are usually processed as grainy or powdery. A drinker can get a brewage conveniently via solving the food product into a cup of water with stirring.

For the further purpose of portability, some inventors design a portable bottle which has a bottle cap. The food product is stored into the bottle cap and a filter net sealing the bottle cap for preventing the food product from dropping into the portable bottle. The drinker enters the cup of water into the portable bottle and closes the bottle cap on the portable bottle; thereafter, the drinker shakes the portable bottle for brewing the brewage from the cup of water and the food product; finally, after the brewage is completely brewed from the cup of water and the food product, the drinker gets the brewage to drink. Therefore, the portable bottle is popular among the travelers and officers.

However, the food product of the portable bottle is exposed in the air without any protection. The food product is easily influenced by much moisture or many bacteria of the air. Even if the bottle cap closes on the portable bottle, there are still the moisture and the bacteria which enter into the portable bottle when manufacturing the portable bottle. Especially the food products would easily spoil due to the moisture or the bacteria of the air. The brewage which is brewed form the spoiled food product will cause a stomach upset to happen to the drinker.

The present invention has arisen to mitigate and/or obviate the disadvantages of the conventional.

### SUMMARY OF THE INVENTION

The main objective of the present invention is to provide an improved portable cup.

To achieve the objective, a portable cup for brewing comprises a cup. A bottom of the cup is defined as a bottom cap. A receiving space is defined on the upper surface of the bottom cap. A food product is received in the receiving space. A soluble edible gum seals the receiving space. A filter net is horizontally placed on the soluble edible gum and is further sealing the receiving space for avoiding the food product from escaping out of the receiving space. A lid covers the top opening of the cup for preventing the outside air from flowing into the cup. The bottom cap is removable from the cup.

Wherein, the food product is fully protected by the soluble edible gum from exposing in the air for preserving the food product from corrupt.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a portable cup for brewing in accordance with the present invention;

FIG. 2 is an assembled cross-sectional view of the portable cup for brewing for showing a soluble edible gum which is sealing a receiving space defined on the upper surface of a bottom cap;

FIG. 3 is an exploded view of the portable cup for brewing of a second embodiment; and

FIG. 4 is an assembled cross-sectional view of the portable cup for brewing of the second embodiment for showing a filter net horizontally placed on the soluble edible gum.

### DETAILED DESCRIPTION OF THE INVENTION

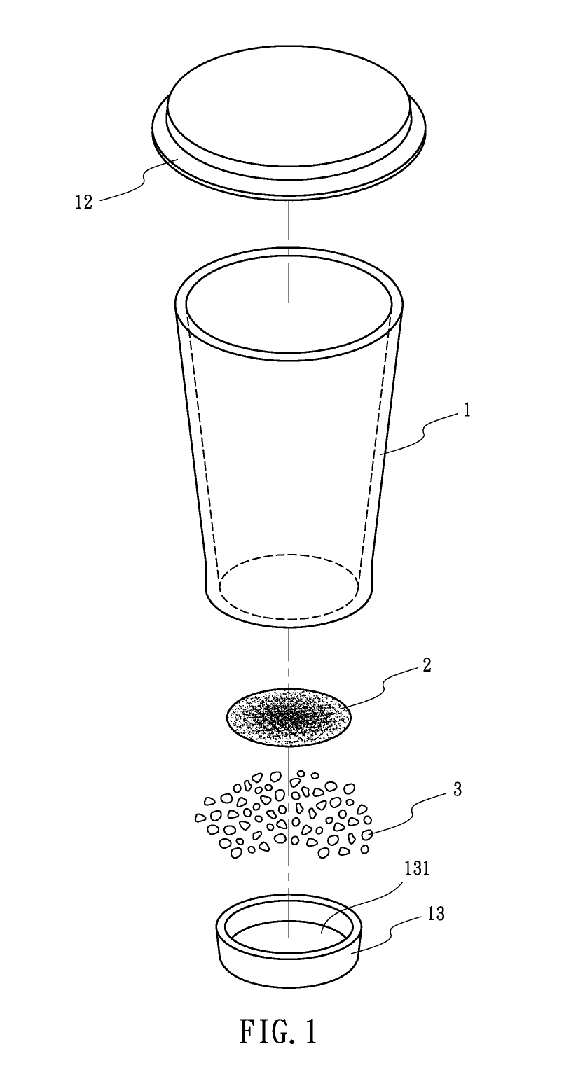

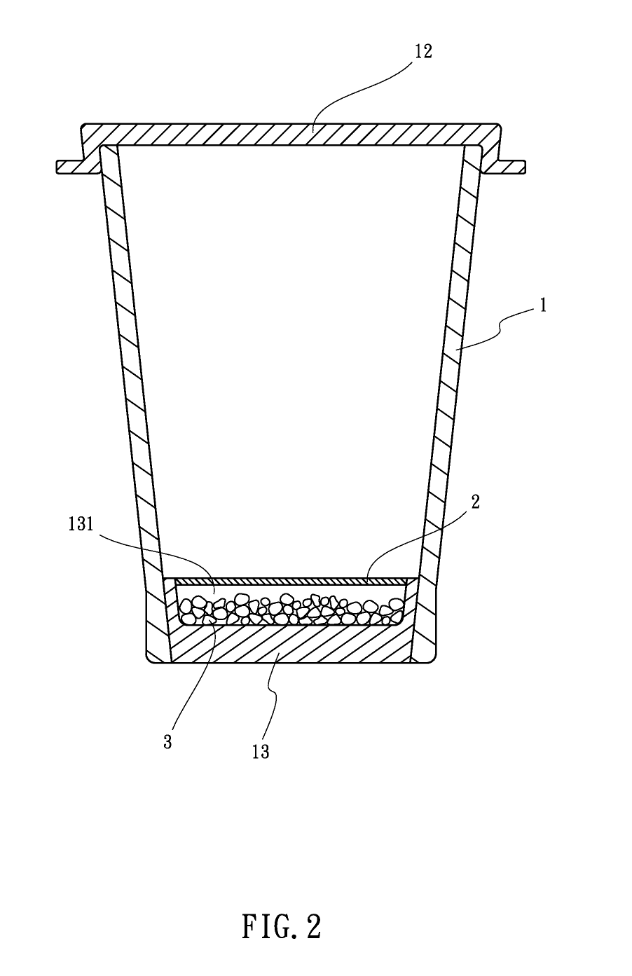

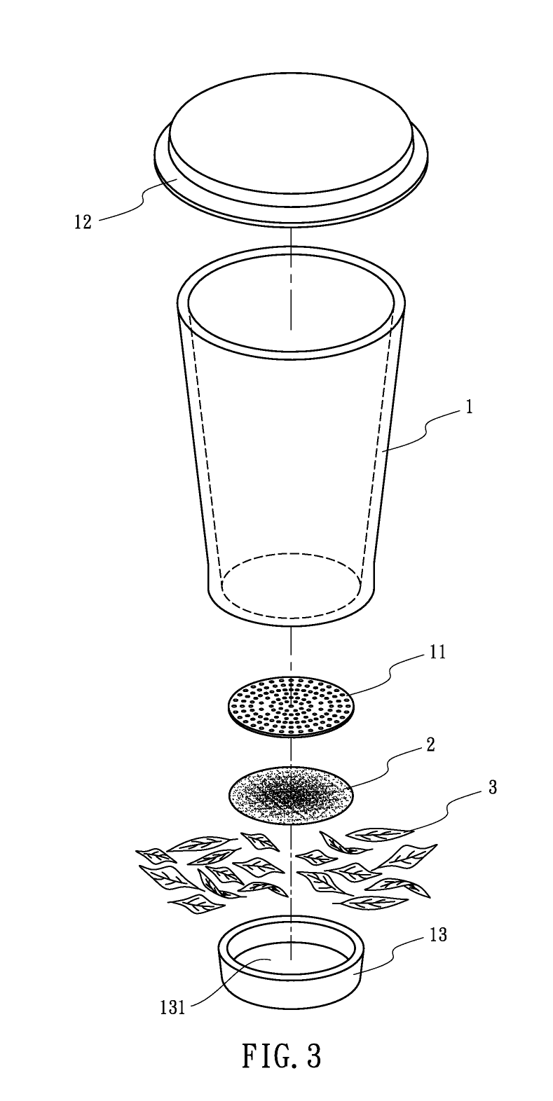

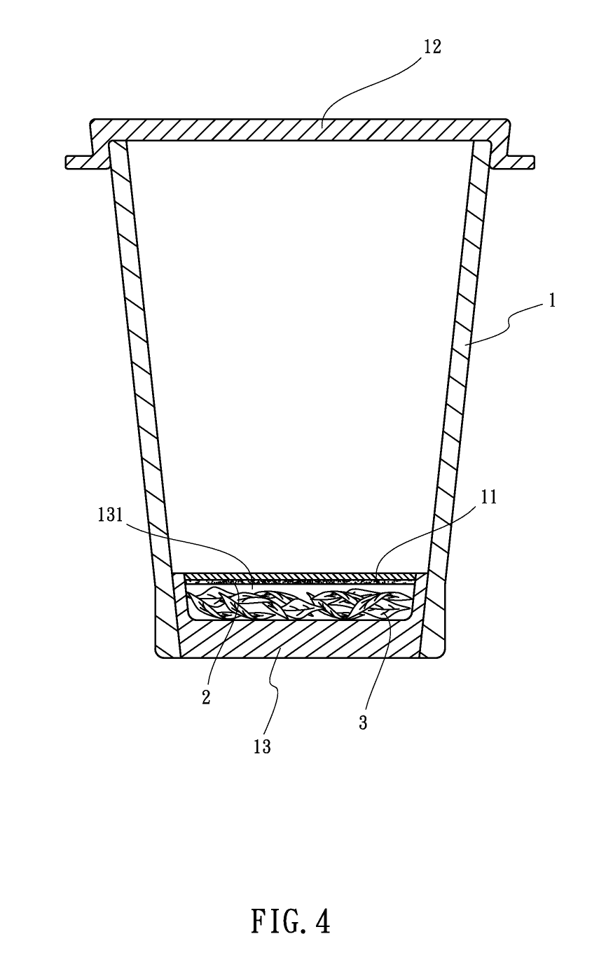

Referring to the drawings to FIGS. 1-2, a portable cup for brewing in accordance with the present invention comprises a cup 1. A bottom of the cup 1 is defined as a bottom cap 13. A receiving space 131 is defined on the upper surface of the bottom cap 13. A food product 3 is received in the receiving space 131 when manufacturing the portable cup for brewing of the present invention. A soluble edible gum 2 seals the receiving space 131. A lid 12 covers the top opening of the cup 1 for preventing outside suspended particle from flowing into the cup 1 and further attaching to the soluble edible gum 2. The bottom cap 13 is removable from the cup 1. Wherein, the food product 3 is fully protected by the soluble edible gum 2 from exposing in the air for preserving the food product 3 from corrupting. The bottom cap 13 is directly combined to the bottom of the cup 1 when manufacturing the portable cup for brewing of the present invention. Therefore, the soluble edible gum 2 fully protects the food product 3 from exposing in the air when manufacturing the portable cup for brewing of the present invention so that the food product 3 of the present invention would not be corrupted by moisture or bacteria of the air. Under this arrangement, when a drinker wants to use the portable cup for brewing of the present invention to brew a brewage from a cup of water and the food product 3, the drinker enters the cup of water into the portable cup for brewing at first; then, the drinker stirs the water in the portable cup for brewing until the soluble edible gum 2 is solved by the water; thereafter, the food product 3 escapes out of the receiving space 131; finally, the food product 3 is completely solved by the water in the portable cup for brewing so that the drinker gets a brewage which is brewed from the cup of water and the food product 3. With reference to FIGS. 3-4, those show a second embodiment of the present invention is described as following (only the features being different form the first embodiment of the present invention are further described). A filter net 11 is horizontally placed on the soluble edible gum 2 and is further sealing the receiving space 131 for avoiding the food product 3 from escaping out of the receiving space 131 when the soluble edible gum 2 is solved by the water. The food product 3 of the second embodiment usually has a larger grain size and cannot be completely solved in water, and is especially uneatable (such as a tea leaf).

Although the invention has been explained in relation to its preferred embodiment, it is to be understood that many other possible modifications and variations can be made without departing from the spirit and scope of the invention as hereinafter claimed.

What is claimed is:

1. A portable cup for brewing comprising:
a cup, a bottom of the cup defined as a bottom cap, a receiving space defined on the upper surface of the bottom cap, a food product received in the receiving space, a soluble edible gum sealing the receiving space;
wherein, the food product is fully protected by the soluble edible gum from exposing in the air for preserving the food product from corrupt.

2. The portable cup for brewing as claimed in claim 1, wherein a filter net is horizontally placed on the soluble edible gum and is further sealing the receiving space for avoiding the food product from escaping out of the receiving space.

3. The portable cup for brewing as claimed in claim 1, wherein a lid covers the top opening of the cup for preventing the outside air from flowing into the cup.

4. The portable cup for brewing as claimed in claim 1, wherein the bottom cap is removable from the cup.
